(19) United States
(12) Patent Application Publication
(10) Pub. No.: US 2024/0086796 A1
(43) Pub. Date: Mar. 14, 2024

(54) SYSTEM AND METHOD FOR INTELLIGENT PERSONALIZED SCREEN RECORDING

(71) Applicant: Nice Ltd., Ra'anana (IL)

(72) Inventors: Ofir MECAYTEN, Karkur (IL); Yaron COHEN, Modiin (IL); Gil NAKASH, Modiin (IL)

(73) Assignee: Nice Ltd., Ra'anana (IL)

(21) Appl. No.: 17/942,633

(22) Filed: Sep. 12, 2022

(51) Int. Cl. G06Q 10/06

(52) U.S. Cl. CPC G06Q 10/063114; G06Q 10/06395; G06Q 10/06398

(57) ABSTRACT

A computerized system and method may determine the recording and/or storing and/or deleting of data items received from remotely connected computer systems, which may be for example interaction recordings associated with a plurality of agents as part of their activity within a given system or organization, using a supervised classification machine learning based approach. A computerized system comprising one or more processors, a communication interface to communicate via a communication network with remote computing devices, and a memory including a data store of a plurality of data items, may be used for extracting features from a plurality of data items; predicting evaluation likelihood values based on the features; deriving storing percentages for a plurality of remote computing devices; and, based on likelihood values and storing percentages, recording and/or storing and/or deleting a plurality of data items from a data store or database.

### FIELD OF THE INVENTION

The present invention relates to the field of screen data and video recordings, and more specifically to a method and system for predictive screen recording.

### BACKGROUND OF THE INVENTION

To assure high service quality, current systems of contact centers monitor interactions between agents and customers for evaluation purposes and follow up actions, such as coaching plans, agents' performance improvement and the like. The monitoring for evaluation of the agents' performance during interactions may be based on calls recordings and screen recordings of events that took place during the interaction. The events may be for example, usage of applications, request for help from a supervisor during the interaction, usage of knowledgebase, transfer of the interaction to another agent.

Quality Management (QM) policies may be defined to include a predefined number of evolutions per agent per week, commonly two for each agent. A quality plan is a tool that implements quality management policies for quality assurance purposes. QM applications sample interactions and based on predefined filters sends interactions to evaluators for review.

Due to a high cost of storage space which the screen recordings of all agent interactions may hold, currently only a specific predetermined percentage of the interactions, e.g., 30 percent, are recorded for each agent, and similarly for all agents. Commonly, an agent maintains many interactions during a shift, but out of the recorded flat percentage, only a few of them, e.g., two interactions per week, may be evaluated for service quality purposes.

The decision of whether interactions should be recorded, e.g., screen recording, and voice recording is random and made at the beginning of the interaction. However, when the decision to operate or initiate screen recording is random and set up to the specific predetermined percentage of the interactions of an agent, then, for high-performing agents, interactions which require correcting feedback might be rare, hence too few recordings for service quality evaluation. For low-performing agents, on the other hand, there may be many interactions that have been recorded, which evaluators may receive and use to provide correcting feedback, therefore most of these screen recordings may be redundant.

Accordingly, there is a need for a technical solution for predicting the necessity of screen recording for each agent, for example at the beginning of each interaction to operate less screen recordings for low-performing agents and more screen recordings for high-performing agents, thus saving the cost of screen recording storage space.

Furthermore, there is a need for a personalized screen recording for each agent in a contact center.

### SUMMARY OF THE INVENTION

A computerized system and method may determine the recording and/or storing and/or deleting of a plurality of data items received from remotely connected computer systems, which may be for example interaction recordings associated with a plurality of agents as part of their activity within a given system or organization, using a supervised classification machine learning based approach. A computerized system comprising one or more processors, a communication interface to communicate via a communication network with remote computing devices, and a memory including a data store of a plurality of data items—which may for example describe a plurality of interactions involving the remote computing devices—may be used for extracting features from a plurality of data items; predicting evaluation likelihood values based on the features; deriving storing percentages for a plurality of remote computing devices; and, based on likelihood values and storing percentages, storing and/or deleting a plurality of data items from a data store or database.

Embodiments may include training a machine learning model, which may be for example a supervised classification model based on data items included in the data store or database and determining a recording or storing policy for a plurality of remote computers or computing devices, which may dictate the recording and/or storing and/or deleting of data items from a data store or database.

In some embodiments, the determining of the recording and/or storing and/or deleting of a plurality of data items received from remotely connected computer systems, and various steps included in or required by the latter, may be performed periodically, e.g., in order to optimize the usage of storage resources in a computing system.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high-level block diagram of an exemplary computing device which may be used with embodiments of the invention.

FIG. 2 illustrates a remote computer system connected via a communication or data network to a computerized system which may be used in some embodiments of the invention.

FIG. 3 illustrates an example high-level architecture and/or connectivity of different components which may be used as part of an intelligent personalized screen recording procedure according to some embodiments of the invention.

FIG. 4 illustrates a technical improvement between previous systems and methods for personalized screen recording and some embodiments of the invention.

FIG. 5 shows a data flow of information between different components according to some embodiments of the invention.

FIG. 6 illustrates an example training lifecycle for an ML model which may be used in some embodiments of the invention.

FIG. 7 shows an example interaction labeling procedure which may be used in some embodiments of the invention.

FIG. 8 shows an intelligent, personalized screen recording procedure according to some embodiments of the present invention.

FIG. 9 shows an example normalization procedure of calculated relative agent recording percentages according to some embodiments of the invention.

FIG. 10 illustrates an example evaluation likelihood and recording percentage or probability table which may be used in some embodiments of the invention.

FIG. 11 shows an example recording policy database which may be used in some embodiments of the invention.

FIG. 12 is a flowchart depicting a simple method for intelligent personalized screen recording according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

Those skilled in the art may recognize that while the discussion herein mainly considers a non-limiting example case of a contact center—where embodiments of the invention may be applied or associated with screen and/or audio recordings and corresponding data items associated with interactions including agents in the contact center—embodiments of the invention may be applied to alternative cases where collecting and/or generating and/or storing and/or utilizing significant amounts of data items may not be limited to, for example, audio and/or screen recordings—and where an intelligent, personalized approach, which may be based for example on supervised learning machine learning models such as described herein may be used for intelligent optimization of storage usage and solve various difficulties associated with limited storage resources in the context of large-scale data collection and maintenance.

It should be noted that in the context of the present disclosure, terms such as “interactions” or “interaction segments” may be used interchangeably (both may, for example, include or be represented by a plurality of data items, and may be described by or associated with a plurality of data items such as historical data elements and/or features and/or feature vectors as described herein). Similarly, terms such as “interaction data”, “metadata”, “historical data elements”, and various “attributes” which may describe or be associated with a given interaction or segment, or with a plurality of such, may be used interchangeably with “data items” in the discussion herein. An interaction may be for example, one or more conversations between an agent and a customer, or other people, including for example telephone or video conversations (e.g. represented by video or voice recordings), text chats, e-mail exchanges, etc.

Embodiments of the invention may provide a method for personalized, intelligent screen or other data recording and/or for optimized utilization of storage resources in a computerized system or device and/or in a system of a plurality of remotely connected such systems or devices. For example, in a computerized system including a processor or a plurality of processors, a communication interface to communicate via a communication network with one or more remote computing devices, and a memory including a data store of a plurality of data items, embodiments of the invention may be used to extract one or more features from a plurality of data items (see, e.g., non-limiting examples for features and corresponding data items in the discussion herein), predict an evaluation likelihood value based on the extracted features for a plurality of additional or different data items, derive storing percentages based on the calculated likelihood values for a plurality of remote computers, and generating and/or storing and/or deleting data items from a database or data store based on the calculated likelihood values and the storing percentages.

In the present disclosure, a contact center will be used as a non-limiting example for an organization which may utilize embodiments of the invention at hand. Those skilled in the art will recognize, however, that different embodiments may be used for various kinds of organizations—which may operate a plurality of agents involved in different activities than the ones considered in a contact or call center environment. The contact center example in the present disclosure should thus be considered as non-limiting.

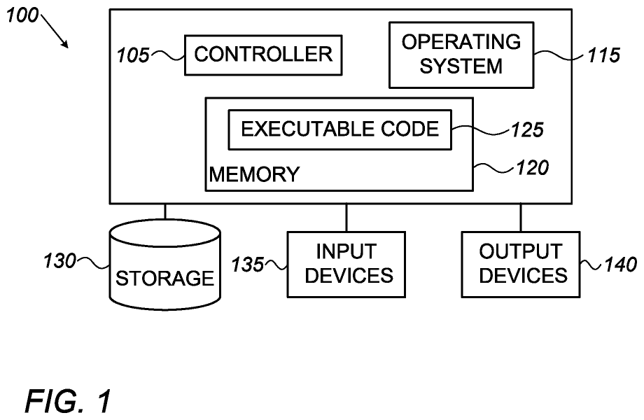

FIG. 1 shows a high-level block diagram of an exemplary computing device which may be used with embodiments of the invention. Computing device 100 may include a controller or processor 105 (or, in some embodiments, a plurality of processors) that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of the procedures and/or calculations discussed herein, and the modules and units discussed, such as intelligent personalized screen recording service 212, data store 228, machine learning model 340, screen recording module 221, recording of events module 222, an automatic call distributor system or program 310, a recording control component 315, a voice recorder 320 and/or screen recorder 325 component(s), and a QM application 330 , may be or include, or may be executed by, a computing device such as included in FIG. 1, although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or a data store of agents' data and metrics as further disclosed herein.

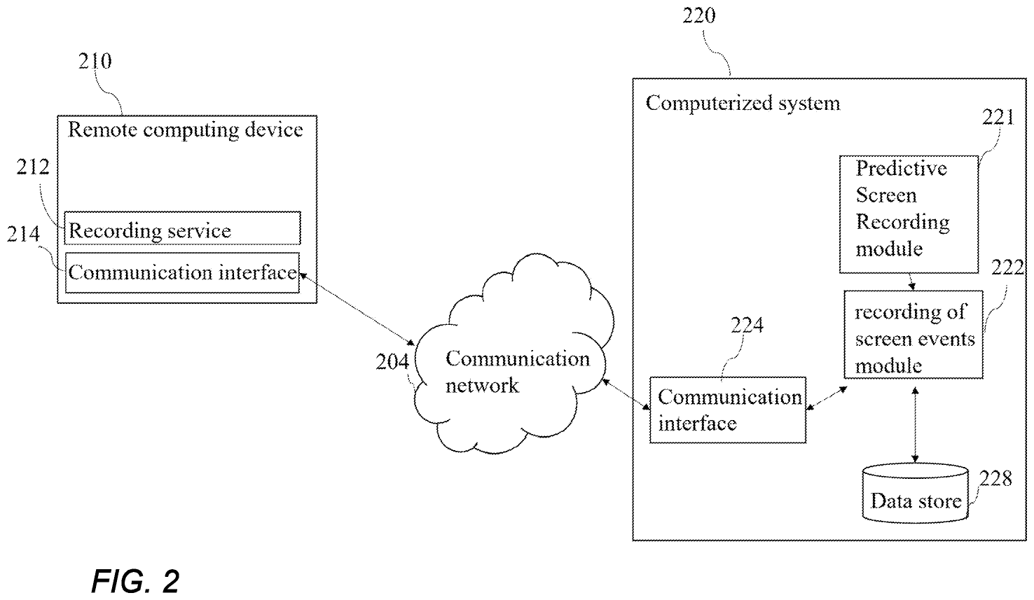

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIGS. 2-6 according to embodiments of the invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such agent data and/or metrics, as well as additional and/or different data items, may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

Memory or memory units 120 may include a data store of, e.g., a plurality of data items such as for example agents' data and metrics, or data items and metrics recorded from a remote computer or a plurality of remote computers, such as further disclosed herein. The processor or processors 105 may operate one or more modules as further disclosed herein. It should be noted that a plurality of physically separate computer systems and/or computational resources which may or may not correspond to the architecture of system 100 (and may include for example ones provided via cloud platforms and/or services) may be for example connected via a data or communication network as a multi-memory and/or processor system, which may be used in some embodiments of the invention. Those skilled in the art may recognize that a plurality of computer system architectures may be used in different embodiments of the invention.

Embodiments of the invention may involve sending or transmitting a plurality of data items (which may for example constitute or represent screen and/or audio recordings) from a plurality of remote computing devices and/or receiving or gathering such data items via for example a communication or data network, and analyzing, by a computerized system (which may conform e.g. to the specifications of system 100) data representing the remote computers, and/or a plurality of remotely-connected computer systems.

FIG. 2 illustrates a remote computer system connected via a communication or data network to a computerized system which may be used in some embodiments of the invention. Remote computer 210, which may for example be operated by an agent in a contact center may send or transmit, over communication or data network 204, a plurality of data items (which may be for example be or include a plurality of screen and/or audio recordings, corresponding for example to interactions or interaction segments involving a plurality of remote computers, which may for example be associated with a given agent or a plurality of agents as further discussed herein) to computerized system 220—which may for example conform to the architecture of system 100, and include a plurality of dedicated modules and/or components as further described herein—in order to carry out various steps which may be required for data processing and/or corresponding calculations according to some embodiments of the invention. In some embodiments, computerized system 220 may additionally perform a plurality of operations including for example sending and/or transmitting and/or collecting and/or receiving data (such as for example processed data and/or calculated results) to or from additional remote computers or computerized systems (which may include for example a cloud-based database or remote services as further described herein). Those skilled in the art may recognize that additional and/or alternative remote and/or computerized systems and/or network and connectivity types may be included in different embodiments of the invention.

In some embodiments of the invention, remote computer 210 and computerized system 220 may communicate via data or communication network 214 via appropriate communication interfaces 214 and 224, respectively—which may be for example network interface controllers (NICs) or network adapters as known in the art. Remote computer 210 may include a recording service 212, which may operate or be used to record or generate a plurality of data items, which may for example correspond or represent screen and/or audio activity performed by an agent or operator of remote computer 210 as further explained herein. Computerized system 220 may include a personalized screen recording module 221 which may include and/or perform some or all of the calculations and/or operations and/or procedures required for intelligent, personalized screen recording as described herein. Screen recording module 221 may record data other than what appears on an agent's computer screen. Personalized screen recording module 221 may then communicate or send calculated outputs to a recording of events module 222, which may accordingly determine or schedule recording operations by recording service 212 on remote computer 210, and receive a plurality of data items which may be or may represent a plurality of screen recording operation performed or executed on remote computer 210, or on a plurality of remote computers. Computerized system 220 may further include a data store 228 which may for example include a plurality of data items including, but not limited to, agents' data and metrics, and/or data items describing a plurality of interactions involving a plurality of remote computers or computing devices, e.g., as further discussed herein. Data store 228 may be used to keep or store the data items received from remote computers by recording of events module 222.

Embodiments of the invention may further utilize recorded and/or extracted and/or collected data items by which for example a given worker or agent's activity or work may be monitored, process the data in order to calculate various metrics and/or performance indicators, and train a machine learning (ML) model designed for executing an intelligent predictive screen recording procedures as described herein.

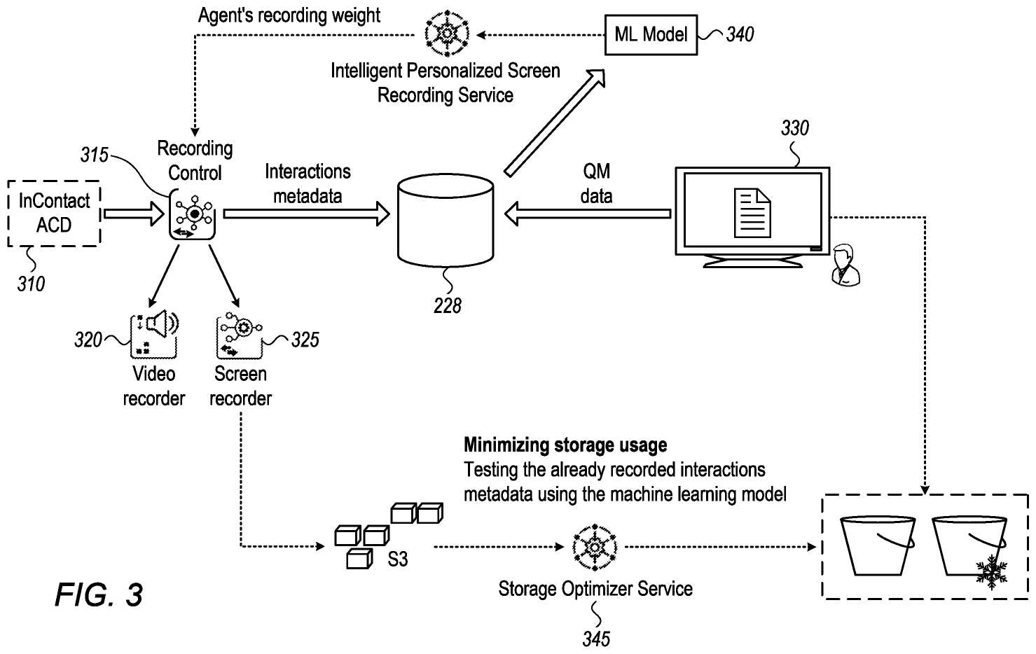

FIG. 3 illustrates an example high-level architecture and/or connectivity of different components which may be used as part of an intelligent personalized screen recording procedure according to some embodiments of the invention. Considering the non-limiting example of a contact center as noted above, a computerized system (such as for example system 220 which may conform to the specifications of system 100) may include or may be associated or connected with an automatic call distributor (ACD) system or program 310, which may be responsible to route a given interaction (e.g., a customer's call) or a plurality of interactions to a specific agent within the contact center (e.g., in order to service a the call). A recording control component 315 (which may be or may include for example modules 221-222 as discussed herein) may include a plurality of components or modules as described in the present disclosure to determine policies or decisions for the recording and/or storing of data items, which may be or may include for example screen and/or audio interactions routed by ACD system 310. Recording control component 315 may determine or schedule a recording operation (e.g., on a given agent's computer, such as for example remote computer 210) involving a voice recorder 320 and screen recorder 325 components. In some embodiments, voice recorder 320 and screen recorder 325 may be included in or operated by recording service 212. A database or data store 228 may include data and/or information items such as for example interaction metadata, which may for example be provided by ACD system 310, or by an agent computer or a plurality of agent computers. In some embodiments, interaction metadata may be gathered or collected by voice recorder 320 and screen recorder 325, in addition to information and/or data items describing or corresponding to a given interaction. In addition, data store 228 may include quality management (QM) data or metrics, which may for example be provided by a QM application 330 used to evaluate agents' performance as known in the art.

Data and/or information items included in data store 228 may be used to train or calibrate a ML model 340, which may be for example a supervised classification learning model, which may include for example a neural-network component or a plurality of such components, to predict whether or not an interaction will be selected for evaluation. ML model 340 may be part of or be used by an intelligent personalized screen recording service or module (which may be for example module 221) to create optimized personalized screen recording policies as further described herein. ML model 340, or an additional or different ML model, may additionally be used as part of a storage optimizer service 345 in the context of choosing or selecting stored interactions which (e.g., with high probability) will not be appropriate for evaluation purposes and may thus be deleted, for example in order to save storage space, as further disclosed herein.

Previous systems and methods for personalized screen recording are based predefined, fixed parameters and weights to determine what interactions are likely to be chosen for evaluation purposes and should therefore be recorded and/or stored in an interaction recording database. For example, in some embodiments, a QM plan may determine that a recording of an interaction which is put on hold for a given amount of time, and for which a correspondingly low sentiment score has been reported by the agent involved in the interaction, should for example be stored in the corresponding recording database for potential evaluation, e.g. by a supervisor. In such an example, the amount of time (e.g., in seconds) during which the interaction was places on hold and the sentiment score (e.g., between 1-10) may be considered as parameters, to which predefined weights are assigned (e.g., 0.5 and −0.5, respectively, meaning that both parameters have equal weights). Embodiments of the invention may improve previous approaches by automatically (e.g., without prior definition of parameters and weights from a human user) extract or calculate various features and/or parameters and/or weights for determining that a given interaction should be recorded or stored in a recording database based on interaction and/or agent features, which may for example be found or stored in data store 228. Thus, embodiments of the invention may improve data storage technology and agent monitoring technology by substantially reducing manual QM interventions in the context of choosing particular interactions for evaluation, or more broadly reduce manually reviewing data elements by a human user in order to choose if they should be stored or deleted from a database. Embodiments may improve current methods and approaches for optimized usage of storage resources in a computing system or device, or in a plurality of such, by offering a solution which may monitor and determine, for example based on vast amounts of data items which cannot possibly be reviewed by a human used in a realistic (e.g., finite) timeframe, the generation and/or storing and/or deletion of data items from a data store or dataset in an automatic and customizable manner (e.g., periodically, using a supervised ML approach, and based on labeling of interactions and/or corresponding data items according to a QM policy as further described herein).

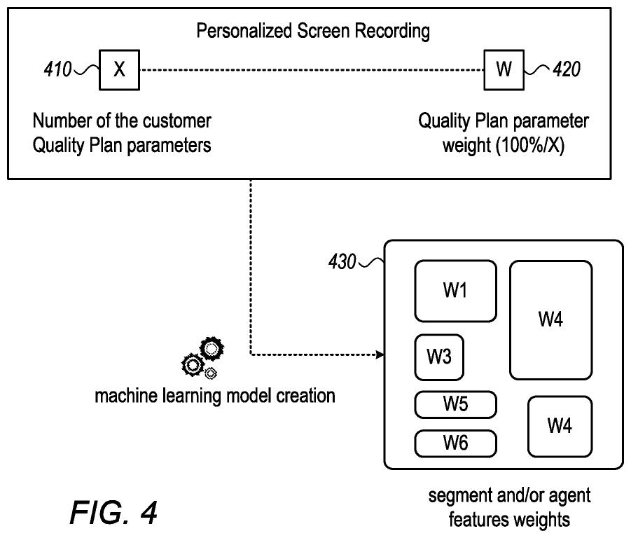

FIG. 4 illustrates a technical improvement between previous systems and methods for personalized screen recording and some embodiments of the invention. In previous solutions, a number of predefined parameters 410, which may for example be related to a customer initiating a given interaction (e.g., sentiment score reported by that customer, a service level agreement for that customer, and the like) may be associated with a corresponding number of weights 420 assigned by an appropriate QM plan to determine a policy for whether a given interaction should be recorded and/or stored in a database. Embodiments of the invention may include an ML model 340 (which may be for example a supervised learning model as further illustrated herein) to revise and/or modify the policy to include for example alternative and/or additional weights 430 to parameters which, e.g., have not been included or considered in the original QM plan. ML model 340 may thus receive a policy such as a QM plan as input, and, together with additional input such as for example agent parameters and interaction metadata as described herein, output a revised or modified recording or storing policy (which may for example be described or characterized by alternative and/or additional weights 430) to determine the recording of an interaction and/or of storing of a given recording in a database as described herein.

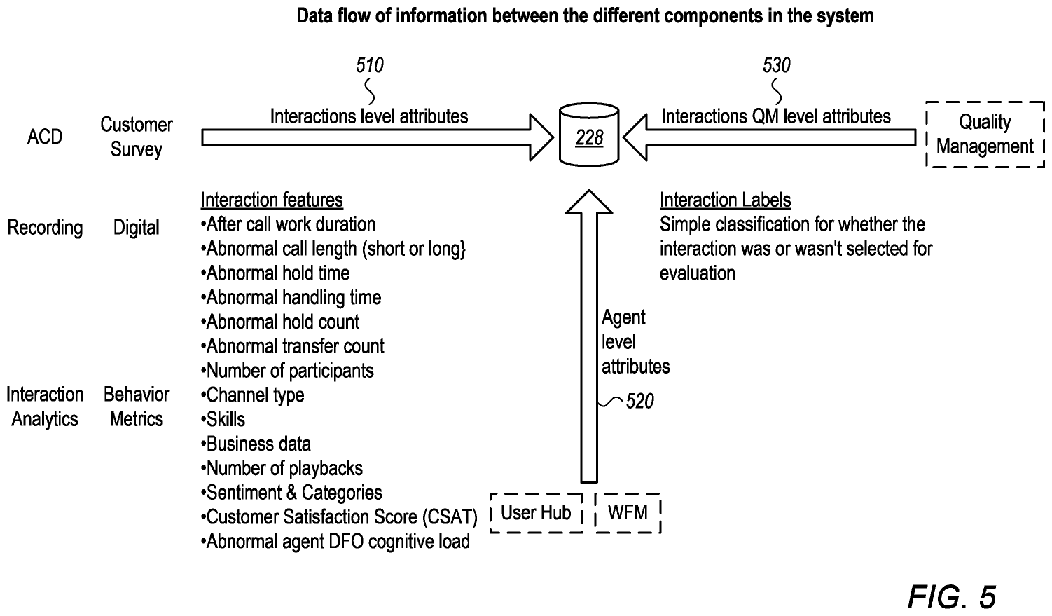

FIG. 5 shows a data flow of information between different components according to some embodiments of the invention. In some embodiments, calculated and/or extracted features associated with data items may be, may include, or may be based on a plurality of attributes as further described herein. Embodiments may use or include interaction level attributes 510, which may for example include a plurality of data items and/or historical data elements and be calculated or derived from a plurality of interaction data and/or metadata and may be used to characterize a given interaction or a plurality of interactions. In some embodiments, interaction data or metadata underlying interaction level attributes 510 may be provided by or gathered from various sources, such as for example ACD system 310, recording services (such as for example service 212 in FIG. 2), and digital data already stored in a database within the system (e.g., interaction recordings and/or corresponding metadata). Additional sources may include, for example, interaction analytics programs or modules, documented or reported customer surveys, documented or reported behavior metrics, and the like, as known in the art.

In some embodiments, interaction level attributes 510, which may be derived and/or extracted from a plurality of data items, or otherwise associated with data items, and/or used as features as described herein, may include a plurality of interaction level aggregations, such as for example the amount of time the agent has dedicated for work related to a given interaction (e.g., “after call work duration” or a task duration after interaction), the number of participants involved in the interaction (or “number of participants per interaction”), and various abnormalities (e.g., defined by appropriate predetermined thresholds) regarding call or interaction length, the amount of time during which the interaction was put on hold, the total interaction handling time or handling time per interaction, the number of times the interaction was put on hold (e.g., “hold count”), and the amount of times the interaction has been transferred to a different agent (e.g., “interaction transfer count”). In some embodiments, such interaction level aggregations may be prespecified and thus drawn or gathered directly from digital data structures (e.g., interaction recordings and/or metadata) stored in appropriate databases within the system (such as for example data store 228).

In some embodiments, interaction level attributes 510 may include the channel type (e.g., voice, video, etc.) used as part of the interaction or with the agent's work associated with the interaction. For example, a given interaction may comprise or be associated with two video calls (e.g., with a customer) and one voice call (e.g., internal to the organization). A plurality of interactions may thus be categorized or labeled based on channel types associated with them.

In some embodiments, interaction level attributes 510 may include behavioral characteristics or behavior metrics, which may include for example manually reported or documented skills for a given agent or a plurality of agents, business data describing a particular transaction and/or contract and/or agreement a given interaction is associated with or related to, a reported or documented number of recording playbacks for a given interaction recording (such as, e.g., the number of supervisor evaluations performed using that recording), manually reported (e.g., by the agent involved in the interaction) interaction scores such as for example sentiment scores and cognitive load scores, as well as manually labeled categories and/or tags to which the interaction may belong (such as for example “customer support”, “complaint”, “hardware problem”, “software problem”, and the like), and manually reported satisfaction score (e.g., by the customer initiating the interaction).

Embodiments may use or include agent level attributes 520, which may be derived and/or extracted from or associated with a plurality of data items, and/or used as features as described herein, and which may for example be collected or gathered from a users' hub of the organization, or from a work force management (WFM) application or program. In some embodiments, agent level attributes 520 may include a plurality of historical data elements and/or agent data and/or metrics such as for example documented or reported agent skills (which may be similar or different than the ones considered herein in the context of interaction level attributes and provided by different sources of information), level of seniority, past record of training other agents (e.g., for experienced agents taking part in training new, unexperienced agents), past performance statistics or performance history, previously reported satisfaction scores, working team and/or group and/or organizational unit to which the agent belongs, adherence information (such as for example meeting past work quota or deadlines) and the like.

Embodiments may use or include QM level attributes 530, which may be derived and/or extracted from or associated with a plurality of data items, and/or used as features as described herein, and which may for example include a plurality of historical data elements that may indicate whether or not a given past interaction was chosen for evaluation by a supervisor or training program. In some embodiments, QM level attributes 530 may be or may include a binary value, such as for example ‘1’ for an interaction which has been chosen or used for evaluation as discussed herein, and ‘0’ for an interaction which has not been chosen for such purposes.

Embodiments may use a plurality of data items and/or historical data elements, including but not limited to interaction level attributes 510, agent level attributes 520, and QM level attributes 530—which may be for example gathered and/or stored in an appropriate database such as, e.g., data store 228—as part of a training procedure of an ML model for intelligent, personalized screen recording as further illustrated herein. In some embodiments, each historical data element or element type (such as for example call duration, agent seniority, and the like) may be used as a row in a feature vector describing a given interaction. A vector may be an ordered list of items. For example, in some embodiments of the invention, a feature vector may take the form of:

```
{
  “feature-vector”: [
  {“ After Call Work Duration in sec”:“21”},
  {“hold count”: “5”},
  {“transfer count”:“2”},
  {“skill”:“support”},
  {“channel”:“digital-chat”},
  {“seniority”:“junior”}
  ]
}
```

Alternative feature vectors of different forms, including alternative features, may be used different embodiments of the invention. A plurality of feature vectors may be used as a training input set for ML model 340 training as further described herein.

In some embodiments, historical data elements may continuously be generated and/or gathered and/or collected and used to train and improve the accuracy level of the ML model 340 consistently. In some embodiments, training data may be labeled based on whether or not an interaction was selected for evaluation (e.g., by a supervisor). Labeling may be generated by QM historical data elements, as well as by manual feedback by evaluators (selected for evaluation—yes/no) and ‘negative sampling’ (which may be or may include for example automatically labeling all interactions for which no manual feedback was received as “negative”, or “not chosen for evaluation”; alternative negative sampling schemes which may take additional labeling factors into account may be used in different embodiments of the invention).

In order to achieve maximum accuracy, some embodiments of the invention may gather training data such as historical data elements and data items from a plurality of different organizations, and/or use or include a different model for different areas or sectors of industry. For example, the training data used for establishing different ML models for intelligent, personalized screen recording within the e-commerce sector may be different from training data used in the context of the healthcare or banking sector. In some embodiments, an industry sector label may be defined by or derived from organization identifiers, which may be for example reported or included in historical data elements used for the training of ML models as discussed herein.

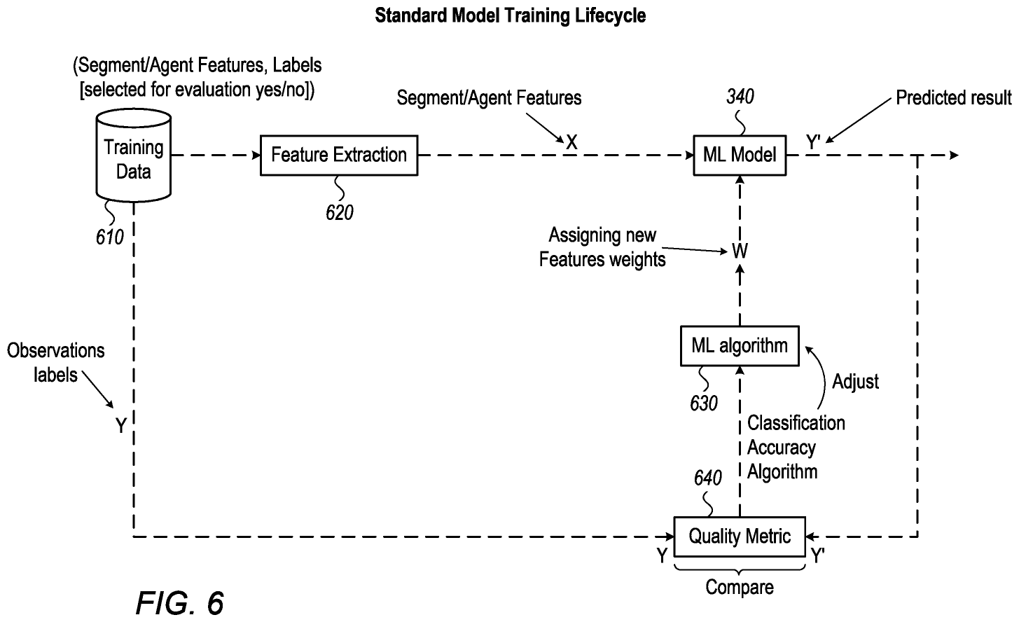

FIG. 6 illustrates an example training lifecycle for an ML model which may be used in some embodiments of the invention. Training data 610 (which may for example be stored in a database such as for example data store 228 and include historical data elements and data item describing or corresponding to ,e.g., interaction level attributes 510, agent level attributes 520, and QM level attributes 530 for a plurality of interactions) may be used in feature extraction (see element 620 herein), where a plurality of features associated with data may be extracted and/or calculated based on input and/or training data. In some embodiments, each feature may be for example a linear combination of input data elements or element types, for which different coefficients or weights W may be assigned or calculated, as known in the art.

ML model 340 may be trained or established based on extracted features and corresponding feature vectors calculated for a plurality of interactions (e.g., based on input or training data stored in data store 228 as described herein). Thus, a plurality of interactions may for example be clustered or distinguished by ML model 340 (for example using linear regression based techniques, or alternative clustering algorithms) based on calculated or extracted features and corresponding feature vectors, as known in the art.

Based on a plurality of extracted features 620 (which may be for example agent features corresponding to or associated with agent level attributes 520, or segment or interaction features corresponding to interaction level attributes 510), ML model 340 may derive a plurality of corresponding feature vectors for a plurality of data items (which may be or may include of interactions involving remote computers and/or agents as described herein) and predict or calculate an evaluation likelihood value Y′ for a given interaction which may not be included in feature extraction 620 and training of ML model 340 as discussed herein. In some embodiments, evaluation likelihood values Y′ may be binary—e.g., an interaction may be assigned either Y′=100% (likely to be chosen for evaluation) or Y′=0% (unlikely to be chosen for evaluation) based on the feature vector calculated for that interaction. In other embodiments, evaluation likelihood values Y′ may be any calculated percentage between 0%-100%. Calculated likelihood values and/or percentages and/or probabilities may subsequently be compared to a predetermined threshold in order to determine whether an interaction will, in fact, be chosen for evaluation, and may accordingly be, e.g., recorded or deleted from data store 228 (an example comparison to predetermined thresholds may be found herein in the context of recording/deleting data items by storage optimizer service). Alternative evaluation likelihood values may be used in different embodiments of the invention.

For example, considering the several features included in the example feature vector discussed herein, ML model 340 may calculate an interaction likelihood value Y′ based on, e.g., example eq. (1):

for (skill=support AND seniority=junior): set Y′=aACWD+bHC+cTC

for (skill=support AND seniority=senior): set Y′=cTC

for (channel=digital−chat)→set Y′=0%

if Y′>τ→set Y′=100%; else set Y′=0% (eq.1)

where ACWD is the after-call-work-duration in seconds, HC is the hold count (e.g., the number of times the call was put on hold), TC is the transfer count (e.g., the number of times the call was transferred to a different agent) a, b, and c are weights which may for example be calculated or derived by ML model 340 or predetermined by a QM policy as described herein, and τ is a predetermined threshold. For illustration purposes, assume a= 1/100, b= 1/10, c= 1/10, and r=70%. Based on eq. 1, ML model 340 may calculate Y′ for an interaction having features such as demonstrated in the example feature vector herein as:

$${Y}^{′} = \frac{1}{100} ( 21 ) + \frac{1}{10} ( 5 ) + \frac{1}{10} ( 2 ) = 91 \% . \qquad ( 21 )$$

Since Y′=91% is larger than τ=70%, embodiments may set Y′=100%, meaning that the interaction or call under consideration is predicted to be chosen for evaluation. Other formulas and/or procedures and/or algorithms may be used for calculating Y′ in different embodiments of the invention.

Observation labels or observed values Y may then confirm or refute the calculated evaluation likelihood value Y′ for a given interaction. For example, once the interaction has been labeled for whether or not it was chosen for evaluation as described herein, embodiments may compare Y′ with Y as part of a classification accuracy assessment algorithm, where a quality metric 640 may be calculated for each of the considered interactions. Based on the calculated quality metric 640 for each interaction, embodiments may include or use a ML algorithm 630 to adjust or assign new coefficients or weights W to each of the features considered in ML model 340.

In some embodiments, a training and prediction cycle (such as for example the training lifecycle illustrated in FIG. 6) may be performed in a periodic or iterative manner (e.g., every X hours, days, weeks, etc.), such that, at each cycle or iteration, a plurality of interactions (such as for example ones for which evaluation likelihood values Y′ were calculated in previous iterations) are added to the training set of ML model 340, and a plurality of evaluation likelihood values Y′ are calculated by ML model 340 for a plurality of different interactions.

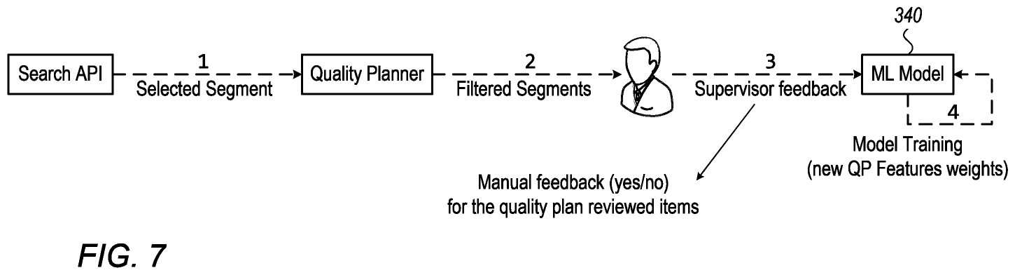

FIG. 7 shows an example interaction labeling procedure which may be used in some embodiments of the invention. A quality planner process (which may for example be defined according to a plurality of QM rules or policies as known in the art) may automatically collect and/or query data store 228 (for example using an appropriate search API) to select the latest or most recent interaction segments (e.g., segments that have been recorded within a predefined amount of hours from the query). The quality planner process may then filter (e.g. choose a subset of, or eliminate unwanted or unused data items) the selected segments based on a fixed set of parameters or parameter values (such as for example interaction lengths exceeding a predefined threshold) to create a filtered set of segments. Filtered segments and their features may then be subject to manual feedback (e.g., by a supervisor) to label and/or signify and/or mark, for each of the filtered interaction segments, if it was or has been chosen for evaluation purposes, or if it is fit for potential evaluation purposes. In some embodiments, interaction segments which have not been manually labeled may be automatically labeled or classified using negative sampling (such as for example automatically labeling segments for which no manual feedback was given as “not chosen for evaluation”, as discussed herein). Based on such labeling or marking (which may, e.g., correspond to the obtaining of the observation labels described herein), ML model 340 may be trained or calibrated, for example comparing model predictions to manually-added labels and by adjusting or assigning new coefficients or weights to features included in ML model 340, as described herein.

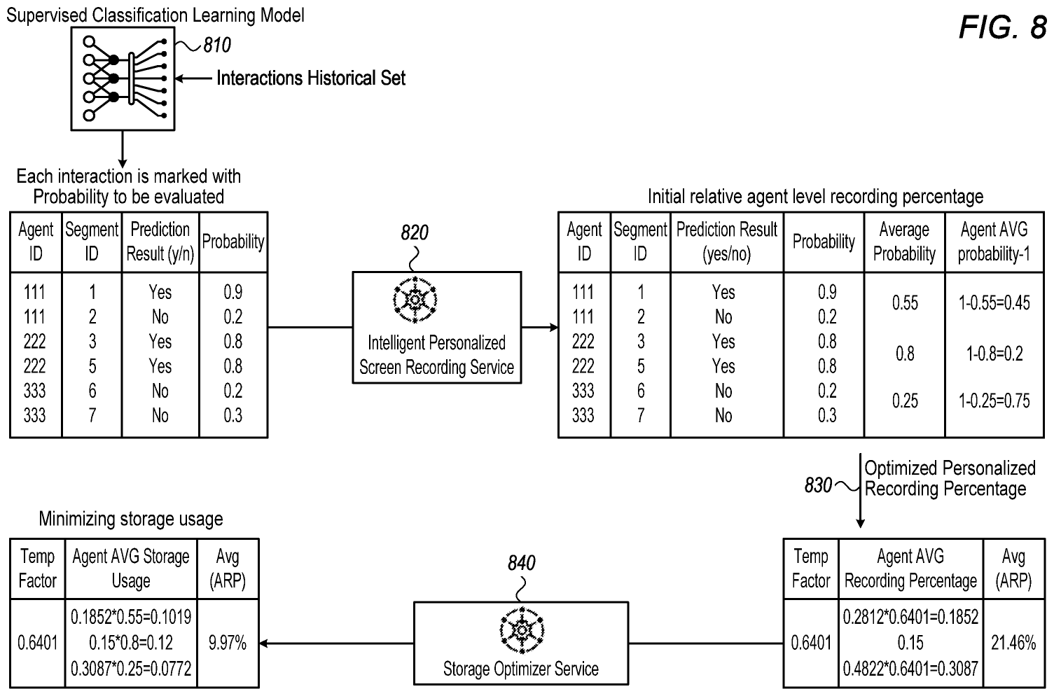

FIG. 8 shows an intelligent, personalized screen recording procedure according to some embodiments of the present invention. In step 810, embodiments of the invention may extract a plurality of features and/or weights from a training dataset (which may consist for example of interaction data and/or metadata elements such as for example historical data elements, including but not limited to interaction level attributes 510, agent level attributes 520, and QM level attributes, which may be found or stored in data store 228 as described herein), to establish ML model 340—which may be for example a supervised classification learning model as described herein. ML model 340 may then be used to predict whether a given interaction or interaction segment is likely to be used for evaluation purposes (e.g., by calculating an evaluation likelihood value or a plurality of values as described herein).

In step 820, an intelligent personalized screen recording service 221 may calculate a relative recording or storing percentage for a plurality of remote computers and/or agents based on predictions and/or evaluation likelihood values calculated by ML model 340, which may describe the relative amount of interactions or interaction segments per agent that may be expected to be selected for evaluation purposes (e.g., by a supervisor evaluating the quality of work by that agent). In some embodiments, an average evaluation likelihood per agent may calculated based on example eq. 2:

$${Y}^{′} ( {a}_{m} ) = \frac{{Σ}_{i = 1}^{n} {Y}_{{s}_{i}} ( {a}_{m} )}{n} \qquad ( eq . 2 )$$

Where Y′(aₘ) is the average evaluation likelihood for agent aₘ, and Yₛ_{ᵢ}(aₘ) is the evaluation likelihood value calculated for interaction segment sᵢ (i=1,2, . . . n) associated with agent aₘ. In some embodiments, a relative storing or recording percentage for a given remote computer, or a relative agent recording percentage may be derived from or calculated based on the average evaluation likelihood for the remote computer or agent under consideration, for example according to example eq. 3:

γₐ_{ₘ}=1−Y′(aₘ) (eq.3)

where γₐ_{ₘ} is the relative agent recording percentage. Eq. 3 may be used for example in order to increase the chances of recording high performing or highly rated agents. Alternative formulas for calculating a relative agent recording percentage may be used in different embodiments of the invention in order to calibrate or modify the chances of recording interactions or interaction segments by a plurality of agents according to various goals or policies made or embraced by the relevant organization or a plurality of organizations.

Embodiments of the invention may then further normalize or optimize a plurality of calculated relative agent recording percentages according to various procedures and rules or based on a plurality of predetermined thresholds and normalization factors (step 830), which may result in a plurality of optimized or normalized recording percentages. In some embodiments, a statistical algorithm may reduce a plurality of recording percentages to a “base recording percentage” as further discussed herein.

In step 840, ML model 340 may be used as part of a storage optimizer service 345, for example in combination with recording percentages calculated in steps 820-830, to predict or calculate evaluation likelihood values for a plurality of interaction segments, which may for example be stored in data store 228 after being recorded from a remote computer by recording service 212 as described herein, or may for example be candidates for being recorded by recording service 212. In some embodiments, storage optimizer service 345 may be configured to delete one or more of the data items describing or associated with interactions or interaction segments for which low evaluation likelihood values were calculated by ML model 340, for example in order to minimize the storage usage on data store 228. In some embodiments of the invention, storage optimizer service 345 may be configured to communicate with recording service 212, such that one or more data items from one or more interactions or interaction segments (such as for example segments for which high evaluation likelihood values were calculated by ML model 340) may be recorded.

In some embodiments, storage optimizer service 345 may operate according to a plurality of predefined rules and/or conditions. For example, storage optimizer service 345 may be configured to cause the recording of a plurality of data items (which may be or may correspond for example to interactions or interaction segments), if the calculated or predicted evaluation likelihood corresponding to these items exceeds a predetermined threshold (such as, e.g., Y′=70%) and/or, for example, if the recording percentage calculated for an agent or for a plurality of agents associated with the data items exceeds a predetermined threshold (such as, e.g., Y′ (aₘ)=70%). Similarly, storage optimizer service 345 may cause the deleting such data items if the calculated or predicted evaluation likelihood is lower than such predetermined threshold, and/or if the recording percentage calculated for an agent or for a plurality of agents associated with the data items are lower than such predetermined threshold. Those skilled in the art may recognize that alternative procedures and/or algorithms and/or rules and/or conditions may be used as part of storage optimizer service 345 in different embodiments of the invention. In some embodiments, the plurality of rules and conditions implemented in storage optimizer service 345 for determining the recording and/or the deleting of data items may be organized and/or stored as a recording policy in an appropriate policy table, as further described herein.

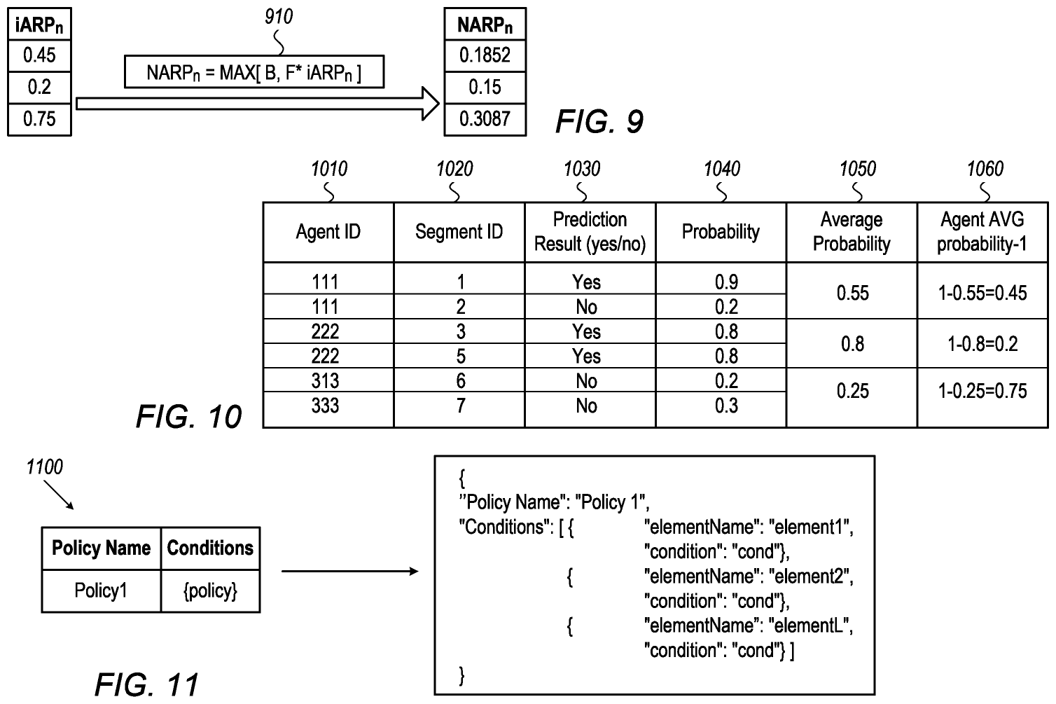

FIG. 9 shows an example normalization procedure of calculated relative agent recording percentages according to some embodiments of the invention. An initial agent recording percentage calculated for agent n (iARPₙ) may be transformed or transposed into a normalized agent recording percentage (NARPₙ) according for example to normalization formula 910, where the maximum among the product of iARPₙ with a normalization factor F and a threshold recording percentage B. In some embodiments, threshold recording percentage B may be predetermined, for example according to an appropriate QM policy. Normalization factor F may, in some embodiments of the invention, be itself a function of the initial agent recording percentage calculated for a given agent. Other normalization formulas and procedures, involving alternative logical and/or algebraic operations may be used in different embodiments of the invention.

Evaluation likelihood values and recording percentages calculated by embodiments of the invention may be organized and stored in various data formats, such as a personal performance indicator (PPIV) table, which may accordingly be used in personalized screen recording procedures as discussed herein.

FIG. 10 illustrates an example evaluation likelihood and recording percentage or probability table which may be used in some embodiments of the invention. In some embodiments, evaluation likelihood values or probabilities 1040 for a plurality of interactions or interaction segments may be sorted or organized according to for example a segment identifier or segment ID 1020. Each segment may be associated with an identifier of the agent involved or responsible for the corresponding interaction or segment, which may be for example agent ID 1010. Embodiments may calculate an average evaluation likelihood value or probability per agent 1050, based on the calculated evaluation likelihood values or probabilities for interactions or segments involving that agent. In some embodiments of the invention, average evaluation likelihood value or probability 1050 may be chosen or selected as a relative recording percentage for a given agent, which may for example be used as part of an intelligent personalized screen recording procedure as described herein. In other embodiments of the invention, average evaluation likelihood value or probability 1050 may be subtracted from unity for the purpose of determining a normalized recording percentage 1060 for the agent under consideration as discussed herein.

Based on calculated evaluation likelihood values or probabilities, embodiments may determine a prediction result 1030 for a given interaction or segment. Prediction result 1030 may, in some embodiments, be a binary value (such as e.g., yes/no)—which may signify whether an interaction or segment is expected to be chosen for evaluation purposes as discussed herein.

Embodiments of the invention may thus determine a recording or storing policy, e.g. for a plurality of remote computers, based for example on extracted and/or calculated features and/or recording percentages, which may dictate or determine the recording and storing or the deleting of data items from data store 228, for example based on prediction results as descried herein. The recording policy determined by embodiments of the invention may for example replace predetermined QM or quality plan policies which may not take into account some or all of the input data considered in ML model 340. Thus, the recording and/or storing of a plurality of data items from a plurality of remote computers (including but not limited to remote computers operated by agents in a contact center which may for example be associated with a plurality of interactions or interaction segments as described herein) and/or from a plurality of interactions or interaction segments, or the deleting of a plurality of such items from a database such as data store 228 may be performed for example based on the policy determined by embodiments of the invention. Policies determined by embodiments of the invention may for example be stored in a database such as data store 228.

In some embodiments of the invention, determining a recording policy, e.g. using ML model 340, may thus involve or include assembling a plurality of feature vectors based on features as described herein, clustering the feature vectors, and training one or more interaction classification models such as for example ML model 340 based on the clustering, e.g. to calculate evaluation likelihood values and recording percentages as described herein.

In some embodiments of the invention, data items which may be stored or deleted from data store 228 may include for example voice interaction data, digital interaction data, screen information data, and interaction metadata—which may for example be further utilized for training ML model 340 as described herein.

FIG. 11 shows an example recording policy database which may be used in some embodiments of the invention. A policy database 1100 may for example include a policy table, which may consist of a plurality of policies stored by appropriate identifiers (such as a policy name). Each policy identifier may be linked to or associated with a plurality of conditions which may define the corresponding policy and may determine—for example based on or according to a plurality of extracted or calculated features, evaluation likelihood values, and recording percentages as described herein—whether an interaction by a given remote computing device or agent should be recorded, whether data items representing an interaction recording should be stored in a database (such as for example data store 228), and whether such data items should be deleted from the database. In some embodiments, policies and conditions may be implemented in a text file which may be linked to the appropriate entry in the policy table based on a policy identifier. In some embodiments, conditions may include logical operators, statistical inferences, and the like—which may be performed on a plurality of features and/or historical data elements and/or recorded data items as described herein. For example, policies set by embodiments of the invention may for example determine storing data elements associated with the recording of interactions involving highly experienced agents (such feature may for example be derived from agent level attributes 520) and number of participants higher than a given threshold (e.g., three participants), while discarding or deleting interactions involving such agents and a number of participants lower than that threshold.

In some embodiments of the invention, a plurality of steps including but not limited to the extraction of features, the calculation of evaluation likelihood values and/or recording percentages, the recording and/or storing and/or deleting of data items from data store 228, the determination of a recording policy, and the training of ML model 340 may be performed periodically (e.g., every X hours, days, weeks, etc.), for example in order to optimize storage usage at a given point in time, thus improving data storage technology.

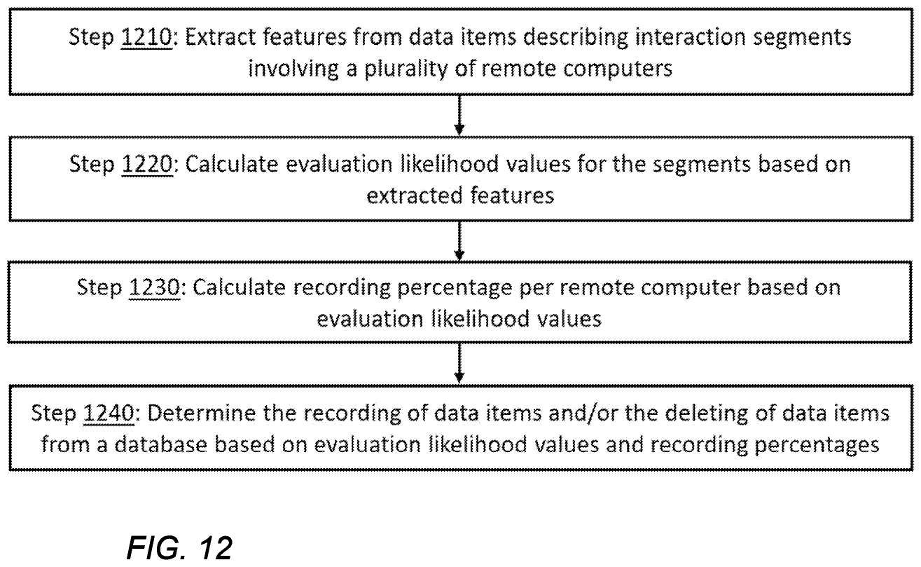

FIG. 12 is a flowchart depicting a simple method for intelligent personalized screen recording according to some embodiments of the invention. In step 1210, a computer processor may be configured to extract a plurality of features from a plurality of data items—which may for example be stored in a database such as data store 228 and describe a plurality of interactions or interaction segments involving a plurality of remote computers. Evaluation likelihood values may then be calculated for a plurality of segments or interactions based on the extracted features (step 1220). A plurality of recording percentages may consequently be calculated for each remote computer based on the evaluation likelihood values (step 1230). Embodiments may then set or determine the recording of a plurality of data items and/or the deleting of data items from the database based on the calculated evaluation likelihood values and recording percentages (step 1240).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A computerized method for personalized screen recording, the computerized-method comprising:
in a computerized system comprising one or more processors, a communication interface to communicate via a communication network with one or more remote computing devices, and a memory including a data store of a plurality of data items, the data items describing a plurality of interactions involving one or more of the remote computing devices:
for one or more of the interactions, calculating an evaluation likelihood value based on one or more features associated with one or more of the data items;
for one or more of the remote computing devices, calculating a recording percentage based on the calculated likelihood values; and
based on one or more of the calculated likelihood values and the calculated recording percentages, performing at least one of: recording one or more data items from one or more interactions on one or more of the remote computing devices, and deleting one or more of the data items from the data store.

2. The computerized method of claim 1, comprising, for one or more remote computers, determining a recording policy based on one or more of the features and the calculated recording percentages, wherein one or more of the data items includes one or more of: agents' data, agents' metrics, and historical data elements; and wherein the recording one or more data items or the deleting one or more of the data items are performed based on the policy.

3. The computerized method of claim 2, wherein one or more of the features comprise one or more of: a handling time per interaction, a task duration after interaction, an interaction length, a number of interactions per timeframe, an interaction hold count, an interaction transfer count, a number of participants per interaction, a channel type, one or more of the agent data or metrics, a number of recording playbacks, one or more interaction scores, and one or more manually labeled categories.

4. The computerized method of claim 2, comprising storing one or more of the data items from one or more of the interactions in the data store, wherein one or more of the data items from one or more of the interactions include one or more of: voice interaction data, digital interaction data, screen information data, and interaction metadata.

5. The computerized method of claim 2, wherein the determining of a recording policy comprises:
assembling one or more feature vectors based on one or more of the features;
clustering one or more of the feature vectors; and
training one or more interaction classification models based on the clustering.

6. The computerized method of claim 1, wherein the calculating of a recording percentage comprises normalizing one or more of the recording percentage based on one or more predetermined thresholds and one or more normalization factors.

7. The computerized method of claim 5, wherein at least one of: the calculating of an evaluation likelihood value, the calculating of a recording percentage, the recording or deleting of one or more data items, the determining of a recording policy, and the storing of one or more data items is performed periodically.

8. The computerized method of claim 1, comprising receiving one or more data items from one or more of the remote computing devices via the communication network.

9. A computerized system for analyzing data representing remotely connected computer systems, the system comprising:
one or more processors,
a communication interface to communicate via a communication network with one or more remote computing devices, and
a memory including a data store of a plurality of data items, the data items describing a plurality of interactions involving one or more of the remote computing devices;
wherein the one or more processors are to:
for one or more of the interactions, calculate an evaluation likelihood value based on one or more of features associated with one or more of the data items;
for one or more of the remote computing devices, calculate a recording percentage based on the calculated likelihood values; and
based on one or more of the calculated likelihood values and the calculated recording percentages, perform at least one of: record one or more data items from one or more interactions on one or more of the remote computing devices, and delete one or more of the data items from the data store.

10. The computerized system of claim 9, wherein the one or more of the processors is to determine a recording policy based on one or more of the features and the calculated recording percentages, wherein one or more of the data items includes one or more of: agents' data, agents' metrics, and historical data elements; and wherein the recording one or more data items or the deleting one or more of the data items are performed based on the policy.

11. The computerized system of claim 10, wherein the one or more of the features comprise one or more of: a handling time per interaction, a task duration after interaction, an interaction length, a number of interactions per timeframe, an interaction hold count, an interaction transfer count, a number of participants per interaction, a channel type, one or more of the agent data or metrics, a number of recording playbacks, one or more interaction scores, and one or more manually labeled categories.

12. The computerized system of claim 10, wherein one or more of the processors is to store one or more of the data items from one or more of the interactions in the data store, wherein one or more of the data items from one or more of the interactions include one or more of: voice interaction data, digital interaction data, screen information data, and interaction metadata.

13. The computerized system of claim 10, wherein one or more of the processors is to:
assemble one or more feature vectors based on one or more of the features;
cluster one or more of the feature vectors; and
train one or more interaction classification models based on the clustering

14. The computerized system of claim 9, wherein one or more of the processors is to normalize one or more of the recording percentage based on one or more predetermined thresholds and one or more normalization factors.

15. The computerized system of claim 13, wherein one or more of the processors is to periodically perform at least one of: the calculating of an evaluation likelihood value, the calculating of a recording percentage, the recording or deleting of one or more data items, the determining of a recording policy, and the storing of one or more data items.

16. The computerized system of claim 9, wherein one or more of the processors is to receive one or more data items from one or more of the remote computing devices via the communication network.

17. A computerized method for intelligent optimization of storage usage, the computerized-method comprising:
in a computerized system comprising one or more processors, a communication interface to communicate via a communication network with one or more remote computing devices, and a memory including a data store of a plurality of data items:
for one or more of the data items, predicting an evaluation likelihood value based on one or more features associated with one or more of the data items;
for one or more of the remote computing devices, deriving a storing percentage based on the calculated likelihood values; and
based on one or more of the calculated likelihood values and the derived storing percentages, performing at least one of: storing one or more data items from one or more interactions on one or more of the remote computing devices, and deleting one or more of the data items from the data store.

18. The computerized method of claim 17, comprising, for one or more remote computers, determining a recording policy based on one or more of the features and the calculated storing percentages.

19. The computerized-system of claim 18, wherein the determining of a recording policy comprises:
training one or more supervised classification machine learning models based on the one or more data items.

20. The computerized-system of claim 19, comprising comparing one or more of the predicted likelihood values with one or more observed values.
